(19) United States
(12) Patent Application Publication
(10) Pub. No.: US 2022/0076246 A1
(43) Pub. Date: Mar. 10, 2022

(54) METHOD, SYSTEM, AND COMPUTER READABLE MEDIUM FOR TRANSFERRING CRYPTOGRAPHIC TOKENS

(71) Applicant: PERK HERO SOFTWARE INC., Vancouver (CA)

(72) Inventors: Desmond Edward Griffin, Vancouver, BC (CA); Angela Maria Griffin, Vancouver, BC (CA)

(73) Assignee: PERK HERO SOFTWARE INC., Vancouver, BC (CA)

(21) Appl. No.: 17/416,354

(22) PCT Filed: Jun. 6, 2019
(86) PCT No.: PCT/CA2019/050789

§ 371 Date: Jun. 18, 2021

Related U.S. Application Data
(60) Provisional application No. 62/782,257, filed on Dec. 19, 2018.

(51) Int. Cl. G06Q 20/36

(52) U.S. Cl. CPC G06Q 20/3678; G06Q 2220/00

(57) ABSTRACT

Cryptographic tokens may be transferred between users of a system. A request may be received from a first user to transfer to a second user at least a part of a float of internal cryptographic tokens. A number of the internal cryptographic tokens drawn from the float are then be sent to a digital wallet of the second user. This sending represents at least one transaction that is recorded on an internal blockchain. The float is obtained in an earlier transaction also recorded on the internal blockchain, and the number of tokens in the float is based on a number of external cryptographic tokens obtained through another earlier transaction recorded on an external blockchain.

This application is a 371 of PCT Application No. PCT/CA2019/050789, filed Jun. 6, 2019, which claims benefit of priority to U.S. Provisional Patent Application No. 62/782,257, Dec. 19, 2018. The above applications are incorporated herein by reference. To the extent that any material in the incorporated application conflicts with material expressly set forth herein, the material expressly set forth herein controls.

### TECHNICAL FIELD

The present disclosure is directed at methods, systems, and techniques for transferring cryptographic tokens.

### BACKGROUND

Cryptographic tokens permit users to exchange resources or assets with each other in a cryptographically secure manner. Each type of cryptographic token is associated with a particular blockchain on which transactions involving that token are recorded. For example, one example type of cryptographic token is the Ether™ token, for which transactions are recorded on the Ethereum™ blockchain. Another example type of cryptographic token is bitcoin, for which transactions are recorded using the bitcoin blockchain.

While recording transactions on a blockchain has certain benefits, such as an expectation that past transactions are immutable, it also has certain practical downsides tied to the technical manner in which blockchain is implemented. For example, processing a transaction on a blockchain may take a relatively long period of time and result in significant transaction fees at large scale.

### SUMMARY

According to a first aspect, there is provided a method comprising: receiving a request from a first user to transfer to a second user at least a part of a float of internal cryptographic tokens; and sending a number of the internal cryptographic tokens drawn from the float to a digital wallet of the second user, wherein the sending is performed using at least one transaction that is recorded on an internal blockchain. The float of internal cryptographic tokens is obtained in an earlier transaction recorded on the internal blockchain, and a number of tokens in the float is based on a number of external cryptographic tokens obtained through another earlier transaction recorded on an external blockchain.

The method may further comprise obtaining the external cryptographic tokens and the float of internal cryptographic tokens through the earlier transactions.

The number of tokens in the float may be identical to the number of external cryptographic tokens.

The first user may be a seller, the second user may be a purchaser, the request may be in response to a payment from the purchaser to the seller, and the method may further comprise determining, by applying computer program code stored on the internal blockchain, the number of internal cryptographic tokens to send to the purchaser.

The request may comprise a message indicating funds are to be paid from the purchaser to the seller, and the method may further comprise sending the funds to a digital wallet of the seller.

The funds may be drawn from the float of the internal cryptographic tokens.

The request may comprise a message that the purchaser has paid the seller.

Sending the internal cryptographic tokens to the digital wallet of the purchaser may comprise sending the internal cryptographic tokens to a digital wallet of the seller, and the seller may subsequently relay the internal cryptographic tokens to the digital wallet of the purchaser.

The internal cryptographic tokens may be sent to the digital wallet of the purchaser without being relayed by the seller.

The method may further comprise storing, on the internal blockchain, at least some transaction details relevant to sending the number of internal cryptographic tokens to the purchaser. The transaction details may comprise any one or more of location data of the purchaser, identity data of the seller, the number of tokens sent to the purchaser, an amount of the payment, and whether the purchaser was referred to the seller.

Determining, using the computer program code stored on the an internal blockchain, the number of internal tokens to send to the purchaser may comprise applying a set of rules that use as inputs any one or more of a number of times the purchaser has visited the seller, a list of other sellers the purchaser has visited, an amount of the payment, whether the purchaser has referred another purchaser to the seller or another seller, and an amount of a previous payment made by the purchaser to the seller.

The float of the internal cryptographic tokens may be obtained through a single transaction, and the sending may be performed multiple times using the float.

The method may further comprise: performing additional transactions using the float of the internal cryptographic tokens, wherein each of the additional transactions is recorded on the internal blockchain; determining a net change in the internal cryptographic tokens resulting from the additional transactions; and reconciling the additional transactions recorded on the internal blockchain with the external blockchain by recording the net change on the external blockchain.

At least one of the users may have an internal digital wallet and an external digital wallet, and the method may further comprise the at least one of the users transferring at least some of the internal cryptographic tokens stored in the internal digital wallet to the external digital wallet. The transferring may comprise: receiving, from the internal digital wallet and in a transaction that is recorded on the internal blockchain, the internal cryptographic tokens to be transferred from the internal digital wallet; determining a number of the external cryptographic tokens to send to the external digital wallet based on the number of internal cryptographic tokens received from the internal digital wallet; and sending, to the external digital wallet and in a transaction that is recorded on the external blockchain, the number of external cryptographic tokens determined based on the number of internal cryptographic tokens received from the internal digital wallet.

The internal blockchain may use proof of authority consensus.

The internal blockchain may be a private blockchain and the external blockchain may be a public blockchain.

According to another aspect, there is provided a method comprising: receiving, from a first user, a request to transfer a payment to a second user; determining a number of internal cryptographic tokens, drawn from a float of the internal cryptographic tokens, based on an amount of the payment; receiving from a digital wallet of the second user the number of internal cryptographic tokens in a transaction that is recorded on an internal blockchain; and transferring the payment to the second user. The float of internal cryptographic tokens is obtained in an earlier transaction recorded on the internal blockchain, and a number of tokens in the float is based on a number of external cryptographic tokens obtained through another earlier transaction recorded on an external blockchain.

According to another aspect, there is provided a system comprising: a processor; a network interface for communicating with an external blockchain, an internal blockchain, a first user, and a second user; a memory having stored thereon computer program code that is executable by the processor and that, when executed by the processor, causes the processor to perform any of the foregoing aspects of the method or suitable combinations thereof.

According to another aspect, there is provided a non-transitory computer readable medium having stored thereon computer program code that is executable by a processor and that, when executed by the processor, causes the processor to perform any of the foregoing aspects of the method or suitable combinations thereof.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a system for transferring cryptographic tokens, according to one example embodiment.

FIG. 2 depicts a computing device used by the user, according to the example embodiment of FIG. 1.

FIG. 3 depicts a method for transferring cryptographic tokens, according to another example embodiment.

FIG. 4 depicts a method for reconciling on an external blockchain transactions that have been recorded on an internal blockchain, which may be used with the example method of FIG. 3.

FIG. 5 depicts a method for transferring cryptographic tokens from a user's internal digital wallet to a user's external digital wallet, that may be used with the example method of FIG. 3.

FIG. 6 depicts a method for transferring cryptographic tokens, according to another example embodiment.

FIG. 7 depicts a system for transferring cryptographic tokens, according to one example embodiment.

FIG. 8 depicts a method for transferring cryptographic tokens, according to another example embodiment.

### DETAILED DESCRIPTION

A blockchain comprises computer nodes on which a distributed database is collectively stored. The database is stored as a chain of “blocks”. The first block in the blockchain is known as a “genesis block”, and every other block in the blockchain is directly linked in a cryptographically secure manner to an immediately preceding block in the chain. This is one way in which any one of the nodes can check the validity of the blockchain.

New blocks added to the blockchain are referred to as being “higher” in the blockchain than the blocks added to the blockchain prior to it; the genesis block is accordingly the “lowest” block in the blockchain. Because each block in the blockchain is directly linked to its immediately preceding block, any block in the blockchain can, directly or indirectly, be traced back to the genesis block.

Different blockchains may be implemented in different ways. In one example blockchain, the bitcoin blockchain, each block of the blockchain comprises that block's size, in bytes; a block header; a transaction counter, representing the number of different bitcoin transactions stored in that block; and transaction data, which are the stored transactions. The block header for each block comprises version information; a previous block hash, which is a reference to the hash of the block immediately preceding that block; a Merkle root, which is a hash of the Merkle tree root of the transactions stored in that block; a timestamp, which is when the block was created; a difficulty target, which is the minimum difficulty that had to be satisfied when performing a proof-of-work operation during block creation; and a nonce, resulting from the proof-of-work.

Using the bitcoin blockchain as an example, different nodes forming the blockchain compete to generate new blocks by performing a proof-of-work operation that satisfies the difficulty target specified in each of the new blocks' headers. Once generated, a new block is disseminated to, and its authenticity is independently verified by, other nodes in the blockchain by using the previous block hash (to confirm that new block's lineage) and Merkle root (to confirm the validity of the transactions stored in that new block). Following verification, the new block is added to the top of the blockchain. The bitcoin blockchain at any given time is typically the chain having blocks resulting from the highest possible cumulative proof-of-work. The nodes are said to have arrived at “consensus” when they agree as to which block is to be added to the top of the blockchain. Each block is cryptographically linked to its immediately preceding block; consequently, blocks far from the top of the blockchain are, for practical purposes, immutable.

Each user who wishes to be able to send and receive cryptographic tokens such as bitcoin has a digital wallet that stores one or more public/private key pairs. For each pair, the private key is kept secret by that user and the public key is made publicly available. One or more tokens are transferred from a first user to a second user using a transaction. For example, a transaction may record that a number of tokens are being transferred from the first user to a public address of a second user, with that address being based on the second user's public key. The first user digitally signs the transaction using the first user's private key for authentication purposes. The transaction is then recorded on the blockchain with which the cryptographic token is associated, which requires another block to be added to that blockchain. A reference to a first user “transferring” a cryptographic token to a second user refers to the first user recording a transaction in which the token is sent to the second user's public address in this or an analogous manner. A reference to a cryptographic token being “stored” in a digital wallet refers to that token having been sent to a public address generated from a public key associated with that wallet.

The distributed and peer-to-peer nature of blockchain is also associated with certain drawbacks. For example, recording a transaction on the blockchain is limited by the speed at which the nodes comprising the blockchain can achieve consensus for a new block. For example, adding a block to the bitcoin blockchain takes on average 10 minutes, and adding a block to the Ethereum™ blockchain takes on average between 10 and 19 seconds. Incentivizing nodes requires them to be paid in some form in order to do the work to maintain and add blocks to the blockchain; consequently, storing data on a blockchain results in transaction fees being incurred. Additionally, by virtue of being distributed the data stored on a blockchain is transmitted to all of that blockchain's nodes, thereby raising data security and privacy issues.

In at least some of the embodiments herein, there are provided methods, systems, and computer readable media for transferring cryptographic tokens. The tokens may be transferred to or received from a user of a system. For example, one user of the system may transfer tokens to another user of the system, either directly or via an intermediary such as a system operator.

The tokens that the users and the operator of the system transfer between each other in accordance with at least some example embodiments are referred to as “internal” tokens. Each transaction involving the internal tokens is recorded in an “internal blockchain”. In order to acquire an initial reserve, or “float”, of the internal tokens, a system operator first obtains a number of cryptographic tokens referred to as “external” tokens. The transaction by which the operator obtains the external tokens is recorded in an “external blockchain”. Following obtaining the external tokens, the operator then obtains the float of internal tokens in a transaction that is recorded in the internal blockchain. In at least some example embodiments, the cryptographic token is the ERC-20 token, the external blockchain is the Ethereum™ blockchain, and the internal blockchain is an Ethereum™ sidechain. The number of internal tokens in the float is based on the number of external tokens that the operator obtained, and in at least some example embodiments is equivalent to that number of external tokens. As discussed further below, transactions recorded on the internal and external blockchains are reconciled with each other from time to time.

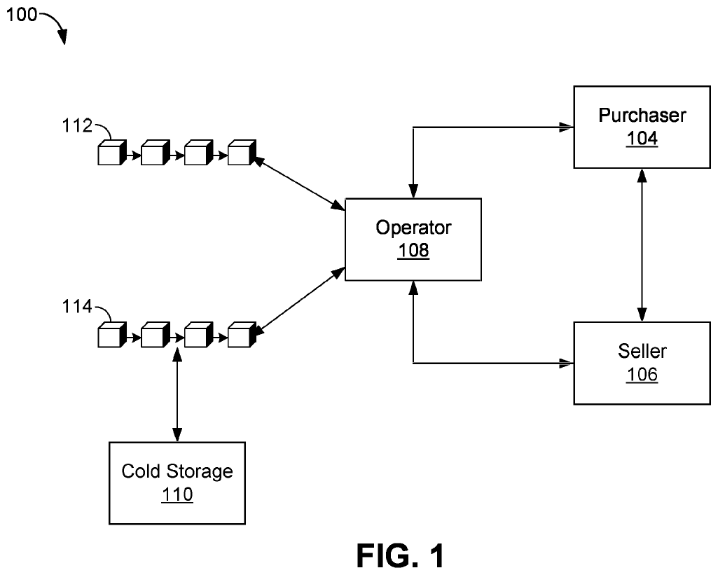

Referring now to FIG. 1, there is shown a system 100 for transferring cryptographic tokens, according to one example embodiment. The system 100 in FIG. 1 shows two users in the form of a purchaser 104 and a seller 106. The purchaser 104 purchases goods and/or services from the seller 106, and internal tokens are transferred to the purchaser 104 as a reward for purchasing those goods and/or services from the seller 106. Each of the purchaser 104 and seller 106 is communicative with a system operator 108 and with each other. The operator 108 is communicative with an external blockchain 114 in which transactions involving the external tokens are recorded, and a sidechain 112, which is an example of an internal blockchain in which transactions involving the internal tokens are recorded. A reserve of the external tokens may be stored in cold storage 110.

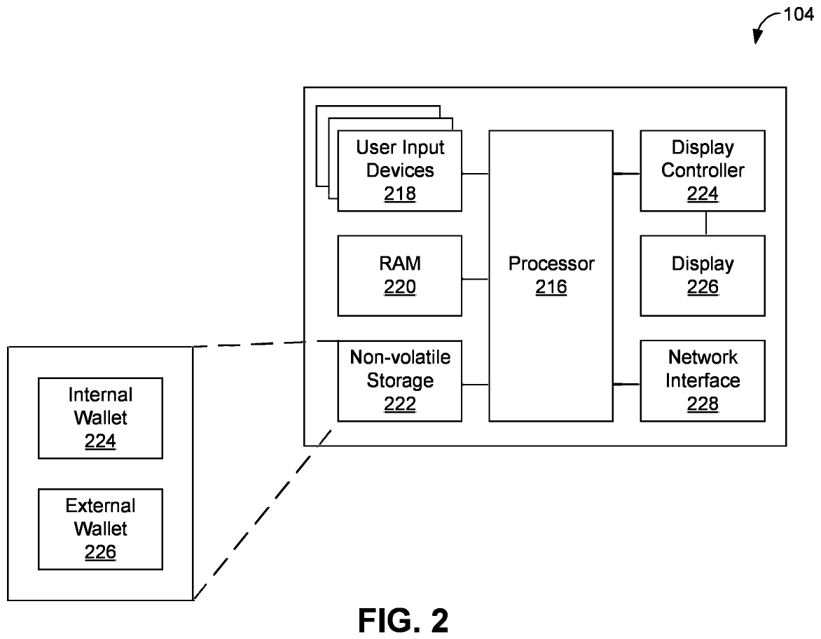

Each of the purchaser 104, seller 106, and operator 108 comprises a computer system, such as that depicted in FIG. 2 for the purchaser 104. In FIG. 2, the purchaser 104 comprises a processor 216 that controls the purchaser's 104 overall operation. The processor 216 is communicatively coupled to and controls subsystems comprising user input devices 218 (e.g., any one or more of a keyboard, mouse, touch screen, and voice control); random access memory (“RAM”) 220, which stores computer program code for execution at runtime by the processor 216; non-volatile storage 222 (e.g., a solid state drive), which stores the computer program code executed by the RAM 220 at runtime and other data, such as an internal wallet 224 and external wallet 226; a display controller 224, which is communicatively coupled to and controls a display 226; and a network interface 228, which facilitates network communications with one or both of the seller 106 and operator 108.

Each of the wallets 224,226 comprises at least one private/public key pair for use in sending or receiving cryptographic tokens. Each party uses its external wallet 226 when participating in transactions transferring (e.g., purchasing or selling) the external tokens, and uses its internal wallet 224 when participating in transactions transferring the internal tokens. The transactions that transfer some of the external tokens are recorded in the external blockchain 114, and the transactions that transfer some of the internal tokens are recoded in the sidechain 112. For example and as mentioned above, to obtain the float of tokens, the operator 108 first purchases a certain number of external tokens; this transaction is recorded in the external blockchain 114, and these tokens are stored in the operator's 108 external wallet 226. A float comprising a number of internal tokens based on the number of external tokens the operator 108 purchased are then transferred to the operator's 108 internal wallet 224, if that wallet 224 is not already storing a sufficient number of tokens. The transaction involving the transfer of internal tokens to the operator's 108 internal wallet 224 is recorded in the sidechain 112. In at least some example embodiments, the number of internal tokens in the float is identical to the number of external tokens purchased by the operator 108, and the operator 108 maintains a relationship between the corresponding internal and external tokens in the form of an exchange rate based on a conversion rate and spread. In some other example embodiments, the number of internal tokens in the float and the external tokens obtained in order to generate the float may differ.

In the depicted example embodiment, the seller 106 and operator 108 comprise identical or analogous systems to that of the purchaser's 104 in FIG. 2. Accordingly, the seller's 106 non-volatile storage 222 also comprises an internal wallet 224 and an external wallet 226 each storing a public/private key paid for receiving and sending internal and external tokens, respectively; and the operator's 108 non-volatile storage 222 also comprises an internal wallet 224 and an external wallet 226 each storing a public/private key paid for receiving and sending internal and external tokens, respectively. Alternatively, one or both of the seller 106 and operator 108 may comprise a different system. For example, the operator 108 may comprise a rack mounted server, and in the normal course lack the display controller 224 and display 226.

Each of the external blockchain 114 and the sidechain 112 may use any suitable method to determine consensus, such as proof of authority, proof of work, and proof of stake. In at least the depicted example embodiment, the sidechain 112 achieves consensus using proof of authority and accordingly comprises “signing” nodes and “sealer” nodes. The signing nodes determine which nodes are to be the sealer nodes, and the sealer nodes are the nodes of which a majority determine whether a block is to be added to the sidechain 112. The operator 108 is the first signing node, and may add one or more signing nodes and sealer nodes as desired. In at least some example embodiments, the purchaser 104 and/or the seller 106 may also be nodes.

The sidechain 112 in at least the depicted example embodiment is private (i.e., permissioned) in that only authorized parties are able to read transaction data from it, and store new transactions (via the sealer nodes) on it. However, in some other example embodiments, the sidechain 112 may be public. Similarly, the external blockchain 114 in at least the depicted example embodiment is public, although in at least some different example embodiments it may be private.

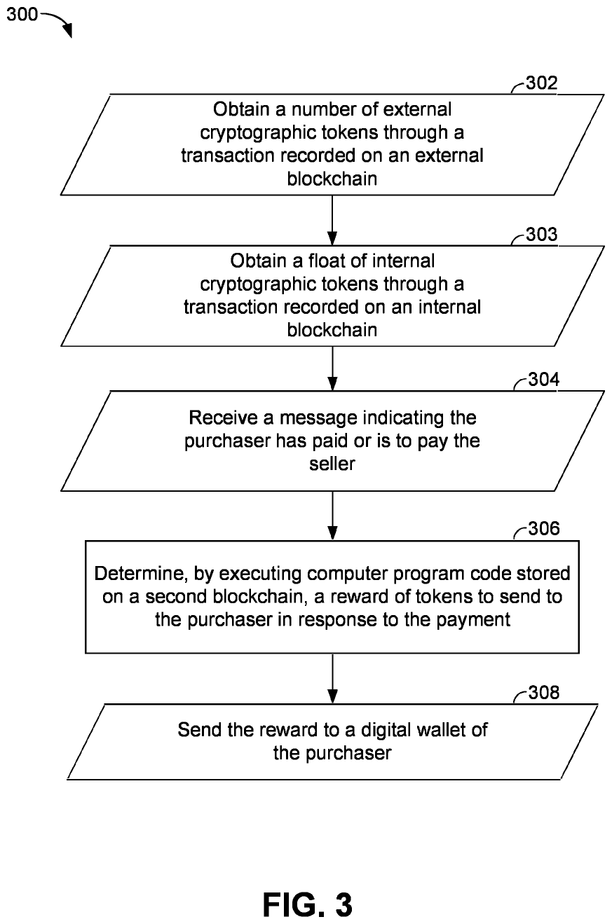

Referring now to FIG. 3, there is depicted a method 300 for transferring cryptographic tokens, and more particularly a reward of the tokens to the purchaser 104, according to an example embodiment. The method 300 may be stored as computer program code on the operator's 108 non-volatile storage 222 and be executable by the operator's 108 processor 216 such that, when executed by the processor 216, the operator 108 performs the method 300.

At block 302 of the method 300, the operator 108 obtains a number of external cryptographic tokens through a transaction recorded on the external blockchain 114. In the example embodiments of FIGS. 1 and 2, the operator 108 obtains the external tokens from cold storage 110. These external tokens are stored in the operator's 108 external wallet 226 and are used as the basis for the float of internal tokens, as discussed above. In an example embodiment in which the external blockchain 114 is the Ethereum™ blockchain and the tokens are ERC-20 tokens, an average of 10 to 19 seconds after the external tokens are sent to the address as determined using the public key in the operator's 108 external wallet 226, a block is added to the external blockchain 114, thereby recording that transaction in that blockchain.

At block 303 of the method 300, the operator 108 obtains the float of internal tokens through a transaction recorded in the sidechain 112, with the size of the float being based on the number of external tokens obtained at block 302 as discussed above. While in FIG. 3 the operator 108 obtains the float at block 303 after securing the external tokens at block 302, in at least some different example embodiments the operator 108 may secure the external tokens after obtaining the float.

Once the operator 108 has the float of tokens, it is able to allocate them between the purchaser 104 and seller 106 using transactions that are recorded on the sidechain 112 and not the external blockchain 114. The operator 108 is able to implement the sidechain 112 in a technically different manner then the external blockchain 114. For example, the operator 108 may implement the sidechain 112 as a private chain, which facilitates privacy and data security when the external blockchain 114 is public. Additionally or alternatively, the sidechain 112 may be implemented to have a more frequent rate of block addition than the external blockchain 114 to increase the speed at which transactions are added to the blockchain 114 and can be considered immutable. This may be done, for example, by having the sidechain 112 follow only reward-related transactions, as opposed to all transactions occurring on the external blockchain 114, and/or by having more nodes involved in consensus on the sidechain 112 than the external blockchain 114. Further, using the sidechain 112 as opposed to the external blockchain 114 may result in lower transaction fees.

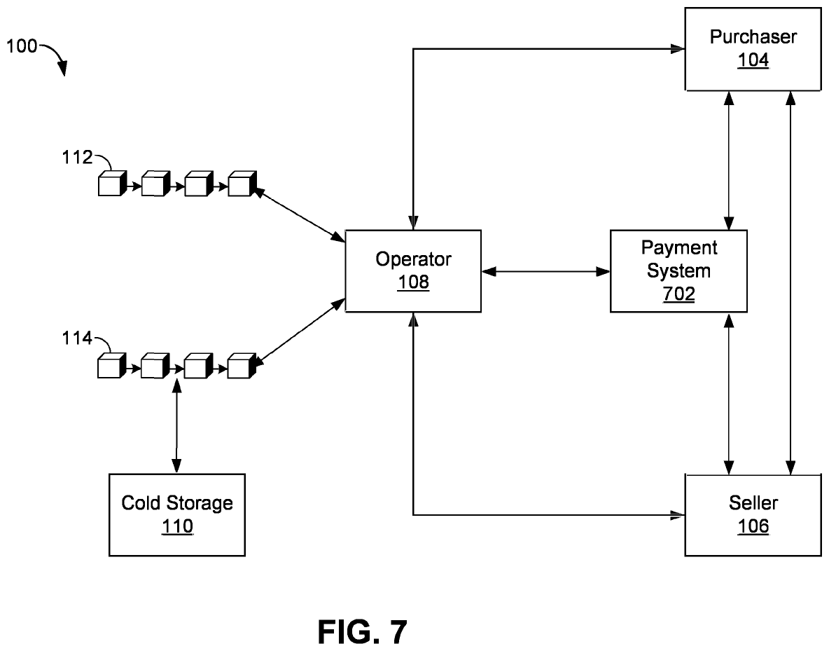

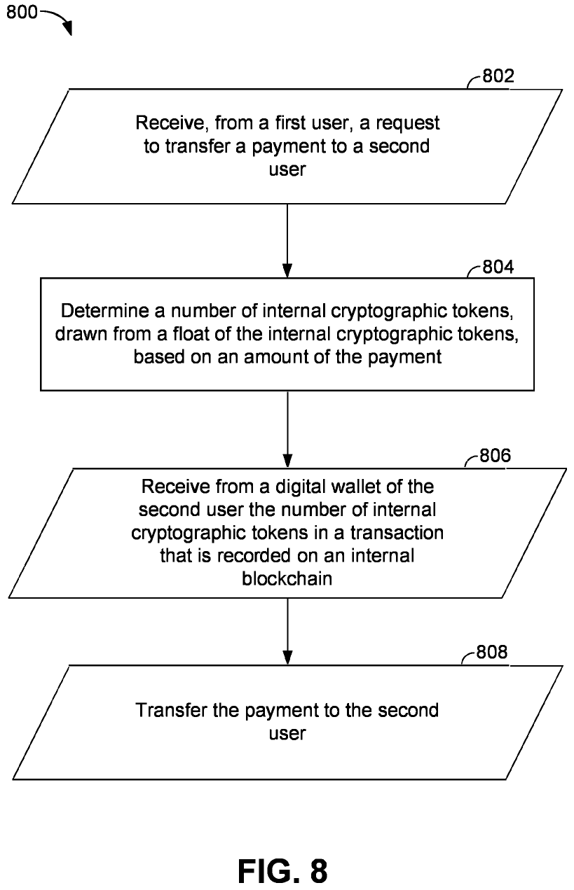

After block 303, the operator 108 proceeds to block 304 in which it receives a message indicating that the purchaser 104 has paid or is to pay the seller 106. For example, the purchaser 104 may have already paid the seller 106 using fiat currency. Alternatively, the notification may indicate that funds are to be paid from the purchaser 104 to the seller 106, in which case the operator 108 may send the funds to the seller's 106 internal wallet 224. For example, the operator 108 may send the funds to the seller 106 according to the teachings of international patent publication no. WO 2018/165746 and published Sep. 20, 2018, the entirety of which is hereby incorporated by reference. Another example of this is discussed in respect of FIGS. 7 and 8 below. In embodiments in which the operator 108 pays the seller 106 on behalf of the purchaser 104, the funds for payment may be drawn from the float of tokens or alternatively comprise a different type of payment such as one or more of another cryptographic token (e.g., bitcoin) and fiat currency. The message that the operator 108 receives at block 304 may come from any suitable party, such as the purchaser 104 or the seller 106.

Following block 304, the operator 108 proceeds to block 306 and determines, by executing computer program code stored on the sidechain 112, a reward of tokens to send to the purchaser 104 in response to the payment. In at least some example embodiments, that computer program code comprises a smart contract stored on the sidechain 112.

Execution of the computer program code may comprise applying a set of rules that use as inputs one or more of a number of times the purchaser 104 has visited the seller 106, a list of other sellers 106 the purchaser has visited, an amount of the payment, the goods and/or services purchased, whether the purchaser 104 has referred another purchaser to the seller 106 or another seller, and an amount of a previous payment made by the purchaser 104 to the seller 106. For example, the operator 108 may determine the reward as any one or more of the following:
(a) a certain percentage of the purchaser's 104 payment;
(b) a set number of tokens for purchasing a particular good and/or service;
(c) a set number of tokens simply for making any purchase from the seller 106;
(d) a set number of tokens after visiting the seller 106 and one or more other sellers who are also part of the operator's 108 rewards program;
(e) a set number of tokens after a person the purchaser 104 has referred to the rewards program has spent a minimum amount and/or made a purchase; and
(f) a set number of tokens after making a purchase from the seller 106 that follows a previous purchase made at the same seller 106 that satisfies a minimum price threshold.

While in the depicted example embodiment the sidechain 112 is used to store both the computer program code and the transactions for transfers of tokens comprising the float, in at least some example embodiments one blockchain may be used to store the computer program code and a different blockchain may be used to record transactions. These blockchains may be configured identically or differently in terms of any number of parameters, such as number of nodes, and whether the chains are public or private.

Following determination of the amount of the reward at block 306, the operator 108 moves to block 308 and sends the reward in tokens to a digital wallet of the purchaser 104, such as the purchaser's 104 internal digital wallet 224. The operator 108 may send the reward directly to the purchaser 104 without the reward being relayed by the seller 106. Alternatively, the operator 108 may relay the reward to the purchaser 104 via the seller 106. For example, the operator 108 may send the reward to the seller's 106 internal wallet 224, from which the seller 106 sends it to the purchaser's 104 internal wallet 224. Relaying the reward through the seller 106 permits the seller 106 to have knowledge of the amount of the reward.

In at least some of the above example embodiments, the operator 108 obtains the external tokens at block 302 used as a basis for the float through a single transaction, and performs the receiving, determining, and sending of blocks 304, 306, and 308 multiple times using the float of tokens corresponding to the single transaction performed at block 302. This allows blocks 304, 306, and 308 to be performed using the sidechain 112 multiple times for each time a single transaction is processed using the external blockchain 114 at block 302, which can be beneficial for embodiments in which the sidechain 112 is faster and/or has lower transactions fees than the external blockchain 114.

From time-to-time, multiple transactions stored on the sidechain 112 are reconciled with the external blockchain 114. In some example embodiments, there is a one-to-one mapping between the transactions stored on the sidechain 112 and the transactions stored on the external blockchain 114. For example, every transaction involving tokens from the float may be recorded in the sidechain 112 and the external blockchain 114. In at least some of these example embodiments, the external blockchain 114 records the identity of the party sending the tokens, the identity of the party receiving the tokens, and the number of tokens transacted; additional information unnecessary to document the transaction, such as how frequently the purchaser 104 visits the seller 106, is excluded from the external blockchain 114.

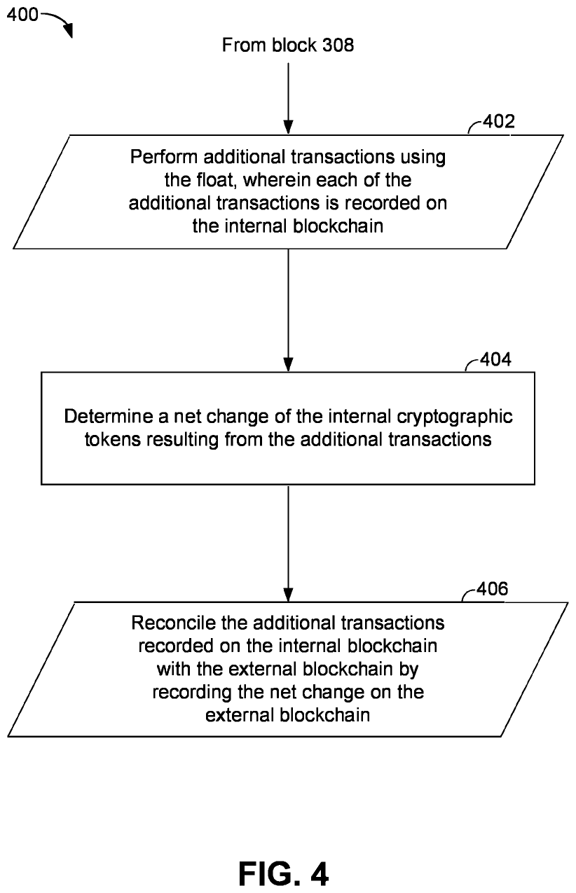

However, in some other example embodiments, the external blockchain 114 is updated less frequently than the sidechain 112, thereby allowing the purchaser 104 and seller 106 to benefit from the sidechain's 114 lower transaction fees and/or better performance. For example, in some embodiments, the operator 108 may set off different transactions recorded on the sidechain 112 against each other, and store only a single transaction representing a net change of tokens on the external blockchain 114. This is demonstrated in the example method 400 shown in FIG. 4, which the operator 108 may perform after block 308 of FIG. 3.

At block 402 of FIG. 4, the operator 108 performs additional transactions using the float, in which each of the additional transactions is recorded on an internal blockchain such as the sidechain 112. For example, the sidechain 112 may store a first transaction in which 100 tokens are transferred from the operator 108 to the seller 106; a second transaction in which those 100 tokens are then transferred from the seller 106 to the purchaser 104; and a third transaction in which the purchaser 104 purchases goods from the seller 106 with 25 tokens. Instead of recording three transactions in the external blockchain 114, at block 404 the operator 108 determines that the net change in internal tokens resulting from the additional transactions is actually the purchaser 104 receiving 75 tokens from the operator 108, and the seller 106 receiving 25 tokens from the operator 108. At block 406, the operator 108 then reconciles the additional transactions recorded on the sidechain 112 with the external blockchain 114 by recording the net change using only two transactions on the external blockchain 114: a first transaction in which the operator 108 sends the purchaser 104 75 tokens; and a second transaction in which the operator 108 sends the seller 106 25 tokens. Reducing the number of transactions has, in some embodiments, the effect of reducing the transaction fees payable, reducing the time and computational power required to store transaction information on the external blockchain 114, and keeping certain information private on the sidechain 112. In this example, in the above example there is no indication on the external blockchain 114 that the purchaser 104 made a purchase for 25 tokens, nor that the total reward amount was 100 tokens.

As mentioned above, in some example embodiments the external blockchain 114 may be public while the sidechain 112 may be permissioned, or private. The operator 108 may, for example, store on the sidechain 112 transaction details relevant to sending the reward to the purchaser's 104 internal wallet 224 and to the purchaser that precipitated the reward. These transactions details may comprise any one or more of the purchaser's identity 104; the seller's 104 identity; the goods and/or services that the purchaser 104 purchased; location data of the purchaser 104; the number of tokens sent as a reward to the purchaser 104; and any data used by the smart contract on the sidechain 112 when determining the amount of the purchaser's 104 reward, such as an amount of the payment precipitating the reward, how frequently the purchaser 104 visits the seller 106, and whether the purchaser was referred to the seller 106. Not all of these details need also be stored on the external blockchain 114. As discussed above, the external blockchain 114 may in at least some example embodiments only record a net number of external tokens received by the operator 108, thereby enhancing privacy of the system's 100 users and the system's 100 data security.

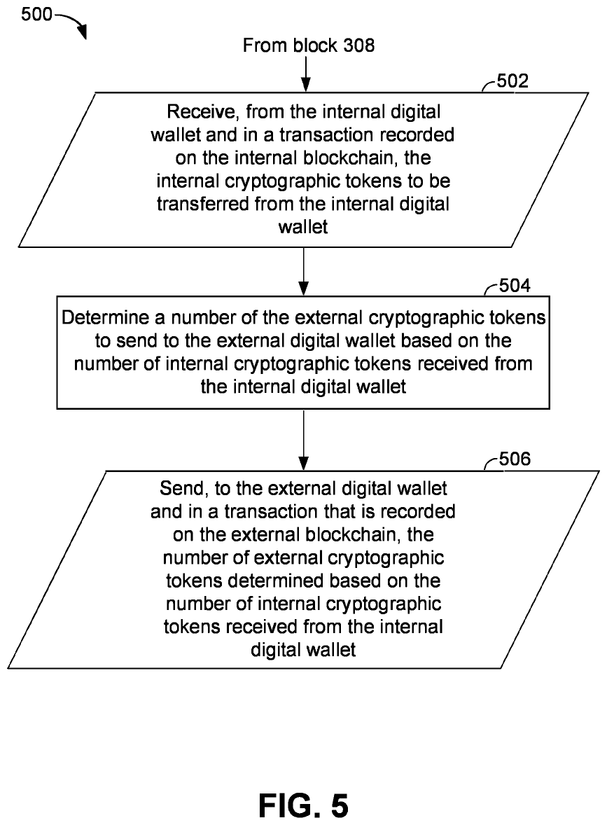

The purchaser 104 may periodically transfer some or all of the tokens stored in its internal wallet 224 to its external wallet 226. FIG. 5 shows one example method 500 that the operator 108 may perform to do this. At block 502, the operator receives, from the purchaser's 108 internal wallet 224 and in a transaction recorded on the sidechain 112, the internal tokens that the purchaser 104 wishes to transfer to its external wallet 226. In the example embodiment of FIG. 1, the operator 108 receives these tokens at its internal wallet 224. At block 504 the operator 108 determines a number of external tokens to send to the purchaser's 104 external wallet 226 based on the number of internal tokens the operator 108 received from the purchaser's 104 internal wallet 224. The operator 108 may do this by applying an exchange rate between the internal and external tokens, with the exchange rate being based on a conversion rate between the tokens and a spread that represents profit for the operator 108. At block 506, the operator 108 sends to the purchaser's 104 external digital wallet 226 and in a transaction that is recorded on the external blockchain 114, the number of external tokens it determined at block 504. In the example embodiment of FIG. 1, the operator 108 sends these tokens from its external wallet 226. The seller 106 may analogously transfer some or all of its tokens from its internal wallet 224 to its external wallet 226.

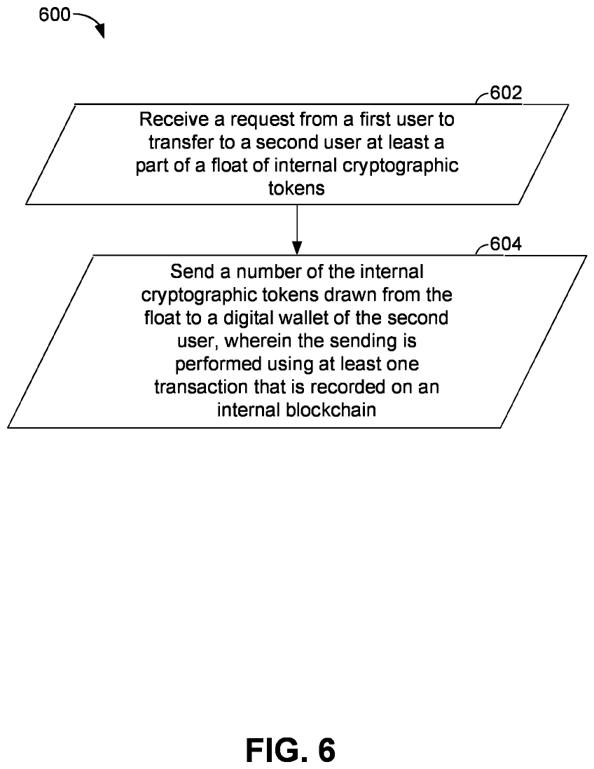

The embodiments of FIGS. 3-5 above are described in the context of a purchase made by the purchaser 104 from the seller 106. However, more generally the system may be used to facilitate a transfer of tokens between any two users regardless of whether one has purchased goods and/or services from the other. This is shown in the example method 600 of FIG. 6.

In FIG. 6, at block 602 the operator 108 receives a request from a first user to transfer to a second user at least part of a float of internal cryptographic tokens. At block 604, the operator 108 sends a number of the internal cryptographic tokens drawn from the float to a digital wallet of the second user, with that sending being performed using at least one transaction that is recorded in an internal blockchain such as the sidechain 112. The float is generated in a manner analogous to that described for FIG. 3. Further, blocks 602 and 604 of FIG. 6 may in at least some embodiments take the place of blocks 304 and 308 of FIG. 3, respectively, and the computer program code referred to in block 306 may be used to determine the number of tokens sent to the second user at block 604.

In at least some example embodiments, the operator 108 may also use the system 100 to transfer a currency other than internal tokens, such as fiat currency, to one of the system's 100 users. The operator 108 may use the embodiment of the system 100 shown in FIG. 7 to do this. The embodiment of the system 100 of FIG. 7 is identical to the embodiment of FIG. 1, except that the system 100 of FIG. 7 further comprises a payment system 702 that is communicative with the purchaser 104, seller 106, and operator 108. The payment system 702 may be a system operated by a bank or some other financial institute and/or service provider that facilitates electronic funds transfer. The operator 108 may then apply the method 800 of FIG. 8 to transfer a non-cryptocurrency to the purchaser 104 and/or seller 106.

In block 802 of FIG. 8, the operator 108 receives, from a first user such as the purchaser 104, a request to transfer a payment to a second user such as the seller 106. The purchaser 104 may wish to purchaser a good and/or service from the seller 106, for example, and wish for the operator 108 to facilitate this purchase. At block 804, the operator 108 determines a number of internal tokens, drawn from the float of internal tokens, based on an amount of the payment. For example, if the amount the purchaser 104 wishes the seller 106 to receive is a certain amount in fiat currency, the operator 108 may convert that amount into cryptocurrency by applying an exchange rate based on a fiat/token conversion rate plus a spread that represents profit. At block 806, the operator 108 receives, from a digital wallet such as the purchaser's 104 internal digital wallet, the number of internal tokens determined at block 804. The transaction representing this transfer is recorded in an internal blockchain such as the sidechain 112. At block 808, the operator 108 transfers the payment to the seller 106 in a form other than in tokens, such as in fiat currency using the payment system 702. The payment system 702 permits an automated transfer of currency from the operator 108 to the seller 106, such as by performing an electronic transfer of funds directly to a bank account of the seller 106. The seller 106 may analogously transfer funds to the purchaser 104.

In at least some example embodiments, the seller 106 may use the system 100 of FIG. 7 to purchase a reward in the form of internal tokens from the operator 108 and relay the reward to the purchaser 104. For example, the purchaser 104 may purchase a good and/or service from the seller 106 and send a message to the operator 108, as described in respect of block 304 above, indicating that it would like to send the purchaser 104 a reward. The operator 108 may then determine the amount of the reward at block 306, and determine a corresponding value in fiat currency for that award by applying a conversion rate to the reward. The operator 108 requests that the seller 106 transfer that corresponding value in fiat currency to the operator 108 using the payment system 702. The seller 106 makes this transfer, and upon receiving that currency the operator 108 sends the reward from its own internal wallet 224 to the seller's 106 wallet 224. The seller 106 then relays that reward from its own internal wallet 224 to the purchaser's 104 internal wallet 224. Collectively, the transfer from the operator 108 to the seller 106, and from the seller 106 to the purchaser 104, of the reward represents the sending of the reward to the purchaser's 104 wallet as contemplated in block 308 above. Alternatively, the operator 108 may transfer the reward directly to the purchaser 104, thereby bypassing the seller 106 from block 308.

The method 600 of FIG. 6 may also apply when the seller 106 wishes to purchase a reward in internal tokens from the operator 108 for transfer to the purchaser 104. For example, applying the method 600 of FIG. 6, the seller 106 may transfer to the operator 108 via the payment system 702 an amount of fiat currency corresponding to the number of tokens with which the seller 106 wishes to reward the purchaser 104. This amount of currency may be predetermined by the operator 106 and be provided to the operator 106 by the seller 106 on request, or may be sent unilaterally by the seller 106 in the expectation that the amount will purchase a sufficient number of internal tokens. Once the operator 108 receives the amount via the payment system 702, it transfers at block 604 a number of the internal tokens corresponding to the amount of the reward from its internal wallet 224 to the purchaser's 104 wallet 224, either directly or via the seller's 106 internal wallet 224.

In FIGS. 1 and 7, the system 100 is depicted as having a single purchaser 104 and seller 106, and the operator 108 has a single external wallet 226 and a single internal wallet 224 for both the purchaser 104 and seller 106. In at least some other embodiments, the system 100 may comprise multiple purchasers 104 and/or multiple sellers 106. In those other embodiments, the operator 108 may use a single external wallet 226 for all purchasers 104 and sellers 106, or assign different purchasers 104 and/or sellers 106 to different wallets 224,226, whether those wallets 224,226 are assigned to only one purchaser 104 and/or seller 106 or shared between multiple purchasers 104 and/or sellers 106. For example, in at least some example embodiments the operator 108 may have a unique pair of internal and external wallets 224,226 for each of the purchasers 104 and sellers 106; this may facilitate subsequent transaction auditing.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this description are intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

In construing the claims, it is to be understood that the use of computer equipment, such as a processor, to implement the embodiments described herein is essential at least where the presence or use of that computer equipment is positively recited in the claims. It is also to be understood that implementing a blockchain inherently requires computer equipment, such as a processor for creating and authenticating new blocks, storage for storing the blockchain, and a network interface for allowing communication between nodes, which is required for consensus.

One or more example embodiments have been described by way of illustration only. This description is been presented for purposes of illustration and description, but is not intended to be exhaustive or limited to the form disclosed. It will be apparent to persons skilled in the art that a number of variations and modifications can be made without departing from the scope of the claims.

1. A method comprising:
(a) receiving a request from a first user to transfer to a second user at least a part of a float of internal cryptographic tokens; and
(b) sending a number of the internal cryptographic tokens drawn from the float to a digital wallet of the second user, wherein the sending is performed using at least one transaction that is recorded on an internal blockchain;
wherein the float of internal cryptographic tokens is obtained in an earlier transaction recorded on the internal blockchain, and a number of tokens in the float is based on a number of external cryptographic tokens obtained through another earlier transaction recorded on an external blockchain.

2. The method of claim 1, further comprising obtaining the external cryptographic tokens and the float of internal cryptographic tokens through the earlier transactions.

3. The method of claim 1 or 2, wherein the number of tokens in the float is identical to the number of external cryptographic tokens.

4. The method of any one of claims 1 to 3, wherein the first user is a seller, the second user is a purchaser, the request is in response to a payment from the purchaser to the seller, and further comprising determining, by applying computer program code stored on the internal blockchain, the number of internal cryptographic tokens to send to the purchaser.

5. The method of claim 4, wherein the request comprises a message indicating funds are to be paid from the purchaser to the seller, and further comprising sending the funds to a digital wallet of the seller.

6. The method of claim 5, wherein the funds are drawn from the float of the internal cryptographic tokens.

7. The method of claim to 4, wherein the request comprises a message that the purchaser has paid the seller.

8. The method of any one of claims 4 to 7, wherein sending the internal cryptographic tokens to the digital wallet of the purchaser comprises sending the internal cryptographic tokens to a digital wallet of the seller, and wherein the seller subsequently relays the internal cryptographic tokens to the digital wallet of the purchaser.

9. The method of any one of claims 4 to 7, wherein the internal cryptographic tokens are sent to the digital wallet of the purchaser without being relayed by the seller.

10. The method of any one of claims 4 to 9, further comprising storing, on the internal blockchain, at least some transaction details relevant to sending the number of internal cryptographic tokens to the purchaser, wherein the transaction details comprise any one or more of location data of the purchaser, identity data of the seller, the number of tokens sent to the purchaser, an amount of the payment, and whether the purchaser was referred to the seller.

11. The method of any one of claims 4 to 10, wherein determining, using the computer program code stored on the an internal blockchain, the number of internal tokens to send to the purchaser comprises applying a set of rules that use as inputs any one or more of a number of times the purchaser has visited the seller, a list of other sellers the purchaser has visited, an amount of the payment, whether the purchaser has referred another purchaser to the seller or another seller, and an amount of a previous payment made by the purchaser to the seller.

12. The method of any one of claims 1 to 11, wherein the float of the internal cryptographic tokens is obtained through a single transaction, and the sending is performed multiple times using the float.

13. The method of any one of claims 1 to 12, further comprising:
(a) performing additional transactions using the float of the internal cryptographic tokens, wherein each of the additional transactions is recorded on the internal blockchain;
(b) determining a net change in the internal cryptographic tokens resulting from the additional transactions; and
(c) reconciling the additional transactions recorded on the internal blockchain with the external blockchain by recording the net change on the external blockchain.

14. The method of any one of claims 1 to 13, wherein at least one of the users has an internal digital wallet and an external digital wallet, and further comprising the at least one of the users transferring at least some of the internal cryptographic tokens stored in the internal digital wallet to the external digital wallet, the transferring comprising:
(a) receiving, from the internal digital wallet and in a transaction that is recorded on the internal blockchain, the internal cryptographic tokens to be transferred from the internal digital wallet;
(b) determining a number of the external cryptographic tokens to send to the external digital wallet based on the number of internal cryptographic tokens received from the internal digital wallet; and
(c) sending, to the external digital wallet and in a transaction that is recorded on the external blockchain, the number of external cryptographic tokens determined based on the number of internal cryptographic tokens received from the internal digital wallet.

15. The method of any one of claims 1 to 14, wherein the internal blockchain uses proof of authority consensus.

16. The method of any one of claims 1 to 15, wherein the internal blockchain is a private blockchain and the external blockchain is a public blockchain.

17. A method comprising:
(a) receiving, from a first user, a request to transfer a payment to a second user;
(b) determining a number of internal cryptographic tokens, drawn from a float of the internal cryptographic tokens, based on an amount of the payment;
(c) receiving from a digital wallet of the second user the number of internal cryptographic tokens in a transaction that is recorded on an internal blockchain; and
(d) transferring the payment to the second user,
wherein the float of internal cryptographic tokens is obtained in an earlier transaction recorded on the internal blockchain, and a number of tokens in the float is based on a number of external cryptographic tokens obtained through another earlier transaction recorded on an external blockchain.

18. A system comprising:
(a) a processor;
(b) a network interface for communicating with an external blockchain, an internal blockchain, a first user, and a second user;
(c) a memory having stored thereon computer program code that is executable by the processor and that, when executed by the processor, causes the processor to perform the method of any one of claims 1 to 17.

19. A non-transitory computer readable medium having stored thereon computer program code that is executable by a processor and that, when executed by the processor, causes the processor to perform the method of any one of claims 1 to 17.
